(19) United States
(12) Patent Application Publication
(10) Pub. No.: US 2012/0097563 A1
(43) Pub. Date: Apr. 26, 2012

(54) KNIFE CARTRIDGE HOLDER

(75) Inventors: Joy A. PACKARD, Hudson, WI (US); Scott D. Gullicks, Woodbury, MN (US); Michael C. Molinet, Woodbury, MN (US)

(73) Assignee: 3M Innovative Properties Company

(21) Appl. No.: 13/282,080

(22) Filed: Oct. 26, 2011

Related U.S. Application Data
(60) Provisional application No. 61/406,819, filed on Oct. 26, 2010.

(51) Int. Cl. B25H 3/02; B65D 85/00

(52) U.S. Cl. 206/372

(57) ABSTRACT

A holder for knife cartridges comprises two chambers connected with a hinge. Each chamber is configured for receiving and holding a knife cartridge. At least one of the chambers is configured to releasably hold a knife cartridge. The holder can be folded at the hinge such that the chambers form an enclosure.

### CROSS REFERENCE TO RELATED APPLICATION

This application claims the benefit of U.S. Provisional Patent Application 61/406819 filed Oct. 26, 2010, the disclosure of which is incorporated by reference herein in its entirety.

### FIELD

This invention relates to holders for replaceable knife cartridges.

### BACKGROUND

Many cutting tools such as, for example, utility knives, package openers, and shaving razor systems use replaceable knife or blade cartridges. Handling and/or replacing the cartridges can be difficult and dangerous. It is therefore desirable to minimize contact or interaction with the knife or blade cartridge. Thus, replaceable knife or blade cartridges are often stored in a holder or dispenser. Such dispensers may contain several separated compartments, which each store one blade cartridge. WO 2005/090020 describes, for example, a dispenser wherein each compartment includes a latch that releasably holds a blade cartridge within the compartment. The compartment retains the blade cartridge in a predetermined position that permits connection of a razor handle to the cartridge. Alternatively, the blade cartridge holder may contain just one compartment and hold only one blade cartridge at a time. Sometimes, blade cartridge holders, particularly single cartridge holders, include a foil or plastic seal to protect the blade cartridge before use.

### SUMMARY

In view of the foregoing, we recognize that there is a need in the art for improved knife cartridge holders that provide easy and safe or “touchless” means of holding, dispensing, and receiving knife cartridges. In addition, we recognize that it would be advantageous if such knife cartridge holders could provide protection for the blade cartridge without the use of expensive foil or plastic seals.

Briefly, the present invention provides a holder for knife cartridges comprising two chambers connected with a hinge. Each chamber is configured for receiving and holding a knife cartridge. At least one of the chambers is configured to releasably hold a knife cartridge. The holder can be folded at the hinge such that the chambers form an enclosure.

In another aspect, the present invention provides a holder for knife cartridges comprising a chamber and a cover connected with a hinge. The chamber is configured for receiving and releasably holding a knife cartridge. The holder can be folded at the hinge such that the chamber and the cover form an enclosure.

As used herein, the terms “knife cartridge” and “blade cartridge” are used interchangeably.

The holders of the present invention enable a “touchless” and safe method for the insertion and removal of replaceable knife cartridges into and from cutting tools. In addition, the holder can be folded and closed so that the chambers form an enclosure. An empty chamber can then, for example, serve as a protective cover for a chamber containing a knife cartridge. A foil or plastic seal is therefore not necessary.

### BRIEF DESCRIPTION OF THE DRAWINGS

FIG. 1 is a perspective view of exemplary knife cartridge holder of the invention 100.

FIG. 2 is another perspective view of holder 100.

FIG. 3 is another perspective view of holder 100.

FIG. 4 is a perspective view of exemplary knife cartridge holder of the invention 200.

FIG. 5 is another perspective view of holder 200.

FIGS. 6A-6F depict use of a knife cartridge holder of the invention with a cutting tool.

### DETAILED DESCRIPTION

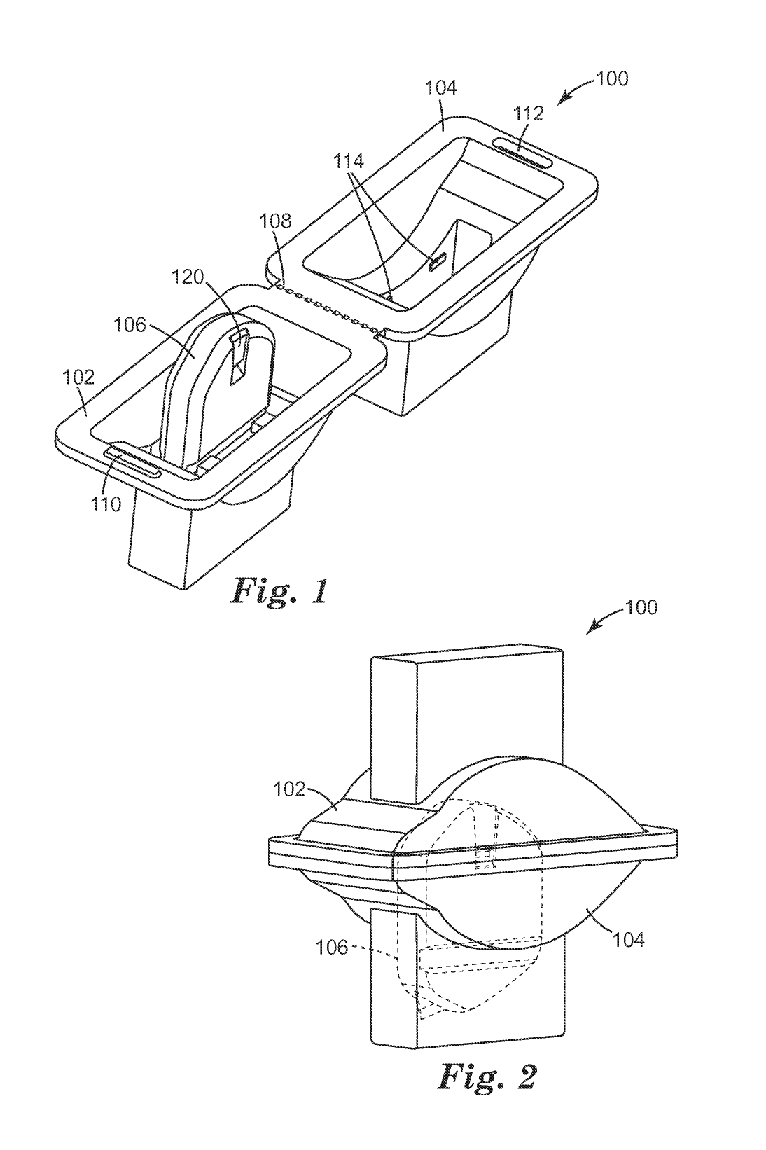

FIG. 1 shows a perspective view of exemplary knife cartridge holder 100. Holder 100 comprises chamber 102 and chamber 104. The chambers are configured for receiving and releasably holding a knife cartridge. In cartridge holder 100, chamber 102 and chamber 104 are substantially similar in shape. In other embodiments of the knife cartridge holder of the invention, the two chambers may have different shapes. As depicted in FIG. 1, chamber 102 releasably holds knife cartridge 106. Features 114 configured to engage with matching features on a knife cartridge can be seen, for example, in chamber 104. Chamber 102 and chamber 104 are connected with hinge 108, which allows chamber 104 to rotate up and over cartridge 106 to form a protective enclosure for cartridge 106. Hinge 108 is a living hinge, but other types of hinges may be utilized. Optionally, living hinge 108 may be perforated as shown in FIG. 1.

FIG. 2 shows a perspective view of knife cartridge holder 100 in a closed position. Empty chamber 104 serves as a protective cover over cartridge 106. The chambers may comprise mating features configured to lock the holder in a closed position when the mating features are engaged. Chamber 102, for example, comprises rib 110 for mating to slot 112 on chamber 104.

When cartridge holder 100 is in an open position as shown in FIG. 1, empty chamber 104 is ready to be utilized as a holder or receptacle for a used knife cartridge (not shown). Chamber 104 may also assist in the removal of the used knife cartridge from a cutting tool.

Alternatively or in addition, when cartridge holder 100 is in an open position, a cutting tool can be positioned over chamber 102 containing new knife cartridge 106 and holder 100 can be used to assist with the insertion of new knife cartridge 106 into the cutting tool.

If, for example, a used knife cartridge has been placed in chamber 104 and new knife cartridge 106 has been inserted into a cutting tool (leaving chamber 102 empty), holder 100 may be closed for storage or disposal. Alternatively, the user may tear hinge 108 along the perforations and remove chamber 104 from empty chamber 102 and dispose of chamber 104 with the used knife cartridge.

FIG. 3 shows another perspective view of knife cartridge holder 100 in an open position. In FIG. 3, knife cartridge 106 is not shown in chamber 102 so that its features may be seen Knife cartridge 106 contains features 116 that engage with features 118 in chamber 102. Features 116 are shown as slots and features 118 are shown as ribs; however any useful engagement features may be utilized Knife cartridge 106 also includes feature 120 (shown as a slot), which can be used for securing the cartridge to a cutting tool.

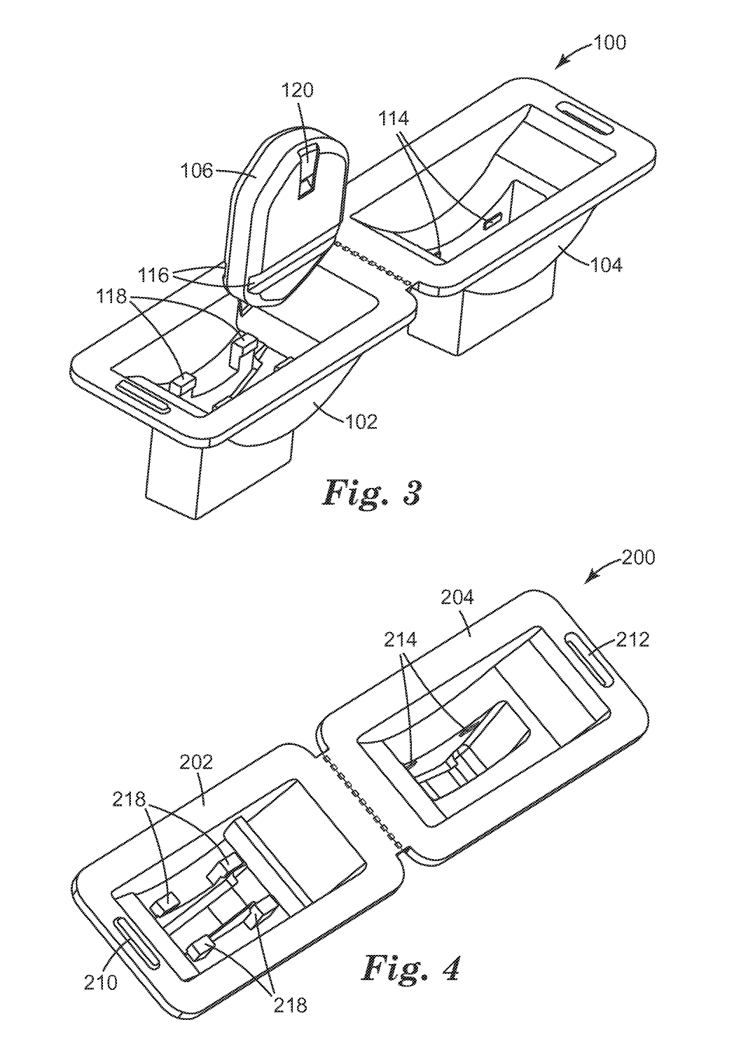

FIG. 4 shows a perspective view of exemplary knife cartridge holder 200. Knife cartridge holder 200 is similar to holder 100, except that chamber 202 is not shaped the same as chamber 204. Chamber 202 is configured to releasably hold an unused or new knife cartridge in a predetermined position that facilitates insertion of the unused cartridge into a cutting tool. Chamber 204 is configured to facilitate removal of a used knife cartridge from a cutting tool. As shown in FIG. 4, chamber 202 is shallower than chamber 204. Chamber 202 is relatively shallow so that the new cartridge sits up higher in the chamber and can be more easily inserted into a cutting tool. Chamber 204, on the other hand, is relatively deep so that when a used cartridge is ejected from a cutting tool, which in many cutting tools results in the cartridge sticking out of the tool, the cartridge can go deeper into the holder and engage with the holder.

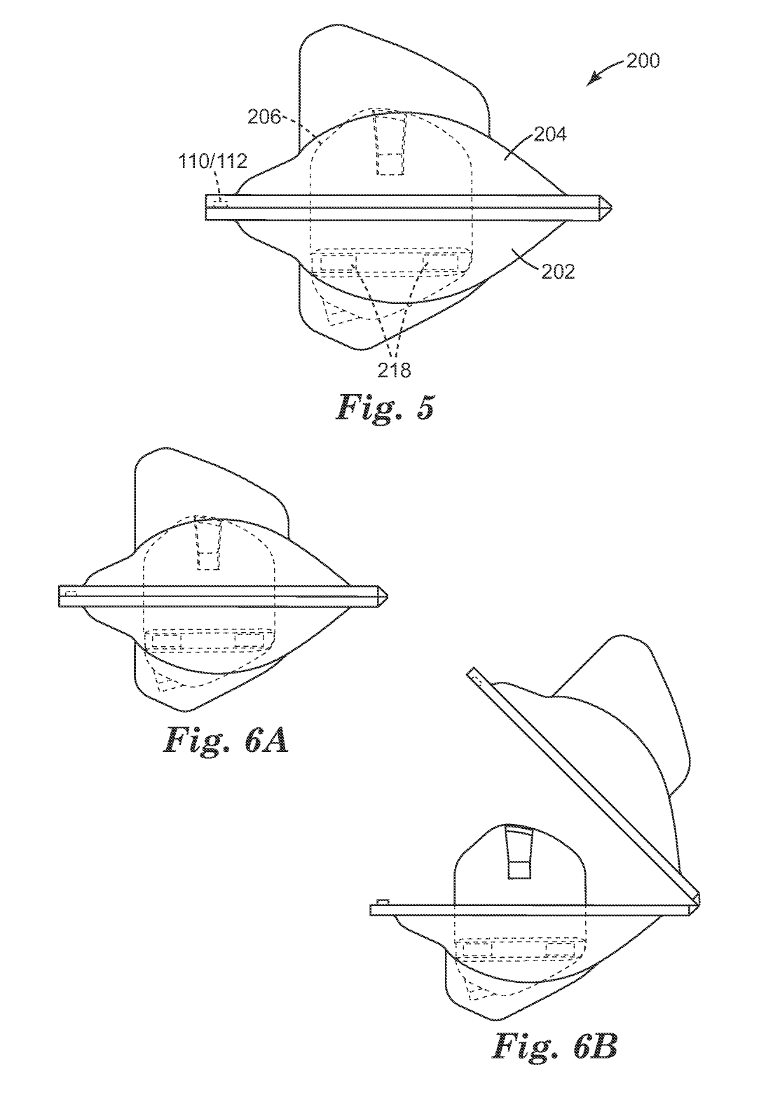

FIG. 5 shows a perspective view of knife cartridge holder 200 in a closed position. Empty chamber 204 serves as a protective cover over cartridge 206.

Although the embodiments of the knife cartridge holders of the invention shown in the figures have only two chambers, some embodiments may comprise more than two chambers.

Knife cartridge holders of the invention are useful for receiving and releasably holding various types of knife cartridges used in many different types of handheld cutting tools. The knife cartridge holders can be used, for example, with knife cartridges used in utility knives, package openers, shaving razor systems, and the like.

The knife cartridge holders of the invention are particularly useful with the cutting tool for opening packages described in co-pending provisional application No. 61/365668, filed Jul. 19, 2010, the contents of which are incorporated herein by reference in their entirety.

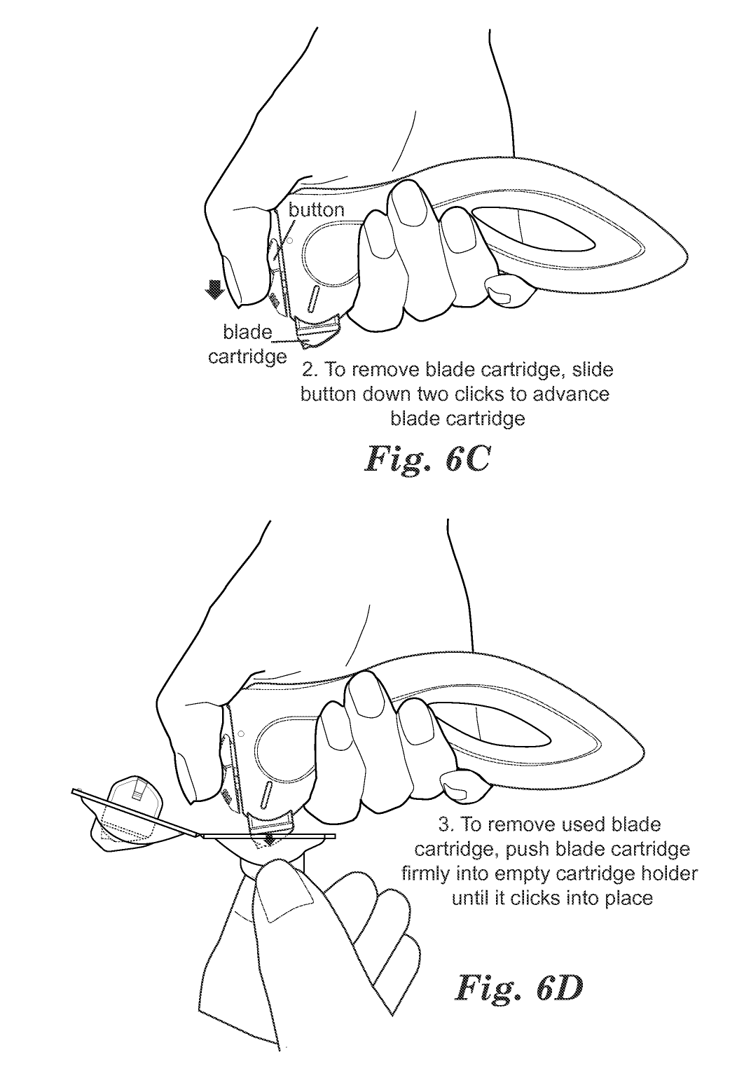

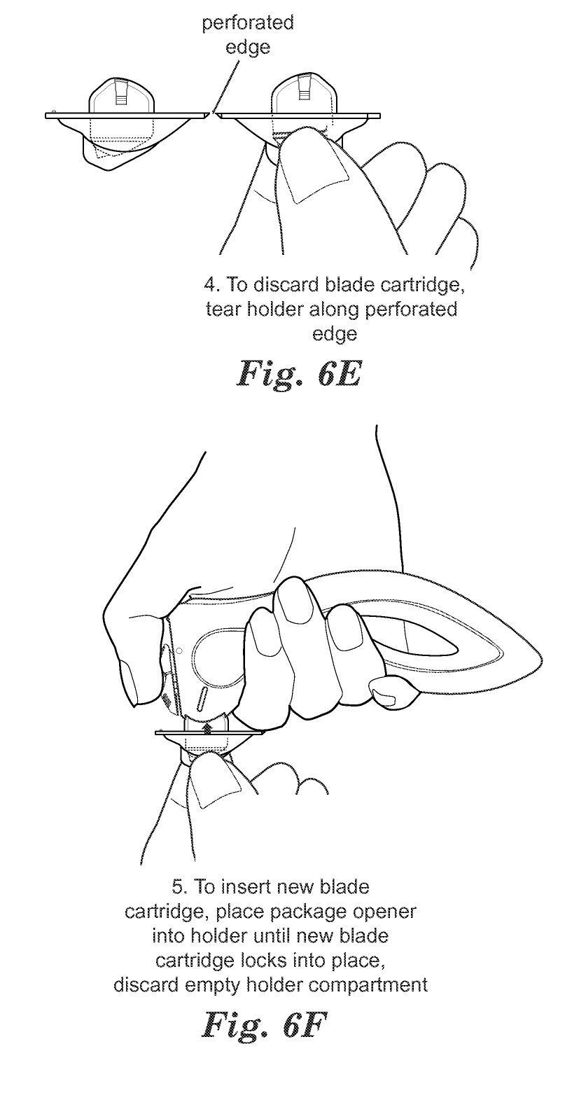

For example, a replacement knife cartridge for such a cutting tool can be provided in a holder of the invention. Typically, the holder would be provided in a closed configuration so that the knife cartridge is enclosed and protected as shown in FIG. 6A. A user would open the cartridge holder as depicted in FIG. 6B. In many instances, the user would need to remove a used blade cartridge from the cutting tool. As shown in FIG. 6C, to remove the used knife cartridge, the cutting tool retractable mechanism is advanced to a discharge position extending the slots (or other useful engagement features) on the cartridge an appropriate distance outside the cutting tool, but the cartridge is still captured by the cutting tool. The cartridge is then positioned inside the holder so that the slots on the cartridge become engaged with the ribs (or other useful engagement features) on the holder as shown in FIG. 6D. Next, the cartridge can be removed from the cutting tool by holding and squeezing the holder while pulling the cutting tool away from the holder. The used knife cartridge remains in the holder making it possible to insert a new knife cartridge in the cutting tool. The used knife cartridge can be safely discarded by tearing away (along the perforated living hinge) the portion of the holder that contains the used knife cartridge as shown in FIG. 6E. To insert a new knife cartridge into the cutting tool, the cutting tool is positioned over the new cartridge contained in the holder with the retractable mechanism set in the discharge position, and the cutting tool is pushed down onto the cartridge until the retractable mechanism engages the knife cartridge ribs (or other useful engagement feature) as shown in FIG. 6F. The new knife cartridge is secured in the cutting tool by moving the tool away from the holder or by positioning the retractable mechanism into the use or storage position.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. A holder for knife cartridges comprising two chambers connected with a hinge, each chamber configured for receiving and holding a knife cartridge; wherein the holder can be folded at the hinge such that the chambers form an enclosure, and wherein at least one of the chambers is configured to releasably hold a knife cartridge.

2. The holder of claim 1 wherein each chamber is configured to releasably hold a knife cartridge.

3. The holder of claim 1 wherein the chambers are positioned longitudinally.

4. The holder of claim 1 wherein the hinge is a living hinge.

5. The holder of claim 4 wherein the living hinge is perforated.

6. The holder of claim 1 wherein at least one chamber comprises features configured to engage with matching features on a knife cartridge.

7. The holder of claim 6 wherein both chambers comprise features configured to engage with matching features on a knife cartridge.

8. The holder of claim 6 wherein the features are ribs configured to engage with matching slots on a knife cartridge.

9. The holder of claim 1 further comprising mating features configured to lock the holder in a closed position when the mating features are engaged.

10. The holder of claim 9 wherein the mating features comprise a rib and a slot.

11. The holder of claim 1 wherein one chamber is configured to releasably hold an unused knife cartridge in a predetermined position that facilitates insertion of the unused knife cartridge into a cutting tool, and the other chamber is configured to facilitate removal of a used knife cartridge from a cutting tool and hold the used knife cartridge.

12. The holder of claim 1 comprising a third chamber connected with a hinge, the chamber configured for receiving and holding a knife cartridge.

13. A holder for knife cartridges comprising a chamber and a cover connected with a hinge, the chamber being configured for receiving and releasably holding a knife cartridge; wherein the holder can be folded at the hinge such that the chamber and the cover form an enclosure.

14. The holder of claim 13 wherein the hinge is a living hinge.

15. A kit comprising the holder of claim 1 and a knife cartridge releasably held in the holder.

16. The kit of claim 15 wherein the holder is folded at the hinge such that the knife cartridge is enclosed in the holder.

17. A kit comprising the holder of claim 13 and a knife cartridge releasably held in the holder.

18. The kit of claim 17 wherein the holder is folded at the hinge such that the knife cartridge is enclosed in the holder.
